(19) United States
(12) Patent Application Publication
(10) Pub. No.: US 2025/0299864 A1
(43) Pub. Date: Sep. 25, 2025

(54) COIL DEVICE AND METHOD FOR MANUFACTURING THE SAME

(71) Applicant: TDK Corporation, Tokyo (JP)

(72) Inventors: Ryosuke IINUMA, Tokyo (JP); Hirofumi SASAKI, Tokyo (JP); Kazuteru KAKIZAKI, Yurihonjo-city (JP)

(73) Assignee: TDK Corporation, Tokyo (JP)

(21) Appl. No.: 19/059,634

(22) Filed: Feb. 21, 2025

(30) Foreign Application Priority Data
Mar. 19, 2024 (JP) 2024-043891

(51) Int. Cl. H01F 27/22; H01F 5/04; H01F 17/04; H01F 41/076

(52) U.S. Cl. CPC H01F 27/22; H01F 5/04; H01F 17/045; H01F 41/076

(57) ABSTRACT

A winding portion includes a dense portion having a relatively large number of layers along a radial direction of the winding portion, and a sparse portion having a relatively small number of layers along the radial direction. A resin bonds the dense portion and a side wall portion of a core portion without bonding the sparse portion and the side wall portion.

This application claims priority to Japanese patent application No.2024-043891 filed on Mar. 19, 2024 which is incorporated herein by reference in its entirety.

### BACKGROUND

The present disclosure relates to a coil device and a method for manufacturing the same.

Conventionally, a coil device including a so-called pot core has been known (for example, refer to Patent Document 1). The pot core is a core having a bottomed cylindrical shape, and includes a core portion having a columnar shape; a side wall portion surrounding the core portion; and a recess located between the core portion and the side wall portion. A coil is accommodated in the recess, and the core portion is inserted into the inside of the coil. A lead-out portion led out from the coil is connected to a terminal provided on the side wall portion.

The recess is filled with a resin, so that heat generated in the coil can be dissipated via the resin. Accordingly, an increase in the temperature of the coil can be prevented.

Patent Document 1: JP H10-4021 A

### SUMMARY

When a variation occurs in the amount of the resin with which the recess is filled, heat dissipation from the coil becomes insufficient, and an increase in the temperature of the coil can be a problem. In addition, when the coil is entirely covered with the resin as in the coil device of Patent Document 1, stress (thermal load) caused by a difference in thermal expansion coefficient between the coil, the resin and the core is likely to be generated, and the inductance characteristics of the coil device may deteriorate.

The present disclosure provides a coil device and a method for manufacturing the same capable of preventing an increase in the temperature of a coil and deterioration of inductance characteristics.

A coil device of the present disclosure includes a core including a core portion having a columnar shape, a side wall portion surrounding the core portion, and a recess located between the core portion and the side wall portion; a wire including a winding portion accommodated in the recess and having a plurality of layers along a radial direction of the core portion, and a lead-out portion led out from the winding portion; a resin adhered to the winding portion; and a terminal connected to the lead-out portion and provided in the side wall portion. The winding portion includes a dense portion having a relatively large number of layers along a radial direction of the winding portion, and a sparse portion having a relatively small number of layers along the radial direction. The resin bonds the dense portion and the side wall portion without bonding the sparse portion and the side wall portion.

The resin may bond an outer peripheral surface of the dense portion and an inner peripheral surface of the side wall portion.

The resin may further bond a bottom surface of the dense portion and a bottom of the recess.

The dense portion may be closer to a bottom of the recess than the sparse portion.

The dense portion may include a first dense portion and a second dense portion closer to a bottom of the recess than the first dense portion. The sparse portion may be located between the first dense portion and the second dense portion along an axial direction of the core portion. The resin may bond the second dense portion and the side wall portion.

The resin may bond the second dense portion and the side wall portion without bonding the first dense portion and the side wall portion and without bonding the sparse portion and the side wall portion.

In a cross-section parallel to an axial direction of the core portion, a surface of the resin may be recessed toward a bottom of the recess between the dense portion and the side wall portion, and may rise as the surface approaches the dense portion and the side wall portion.

The surface of the resin may be raised more in the vicinity of the side wall portion than in the vicinity of the dense portion.

The resin may not bond the core portion and the dense portion.

The dense portion may be in contact with the core portion, whereas the dense portion may not be in contact with the side wall portion and a bottom of the recess.

In a plan view, the resin may locally bond the dense portion and the side wall portion along a path that connects an outer peripheral surface of the winding portion and the terminal in a shortest distance.

A method for manufacturing a coil device of the present disclosure includes the steps of preparing a winding portion including a dense portion having a relatively large number of layers along a radial direction and a sparse portion having a relatively small number of layers along the radial direction; preparing a core including a core portion having a columnar shape, a side wall portion surrounding the core portion, and a recess located between the core portion and the side wall portion; applying a resin to the recess; and a step of accommodating the winding portion in the recess and allowing the resin to enter between the dense portion and the side wall portion.

### BRIEF DESCRIPTION OF THE DRAWINGS

FIG. 1 is a perspective view of a coil device of a first embodiment;

FIG. 2 is a perspective view illustrating an internal configuration of the coil device of FIG. 1;

FIG. 3 is a perspective view of a first core;

FIG. 4 is a perspective view of terminals of FIG. 2;

FIG. 5 is a cross-sectional view taken along line V-V illustrated in FIG. 2;

FIG. 6 is a view illustrating a method for winding a wire;

FIG. 7 is a partially enlarged cross-sectional view of the coil device of FIG. 5;

FIG. 8 is a cross-sectional view of a coil device of a second embodiment;

FIG. 9A is a view illustrating measurement results of the change rate in the inductance characteristics of the coil device;

FIG. 9B is a view illustrating measurement results of the change rate in the inductance characteristics of the coil device;

FIG. 9C is a view illustrating measurement results of the change rate in the inductance characteristics of the coil device;

FIG. 10 is a cross-sectional view of a coil device of a third embodiment;

FIG. 11 is a plan view of a coil device of a fourth embodiment;

FIG. 12 is a cross-sectional view of a modification example of the coil device of FIG. 5; and

FIG. 13 is a cross-sectional view of a modification example of the coil device of FIG. 10.

### DETAILED DESCRIPTION

Hereinafter, embodiments of the present disclosure will be described with reference to the drawings. The illustrated contents are provided schematically and exemplarily merely for the understanding of the present disclosure, and the appearance, dimensional ratio, or the like can be different from the actual product. In addition, the present disclosure is not limited to the following embodiments.

### First Embodiment

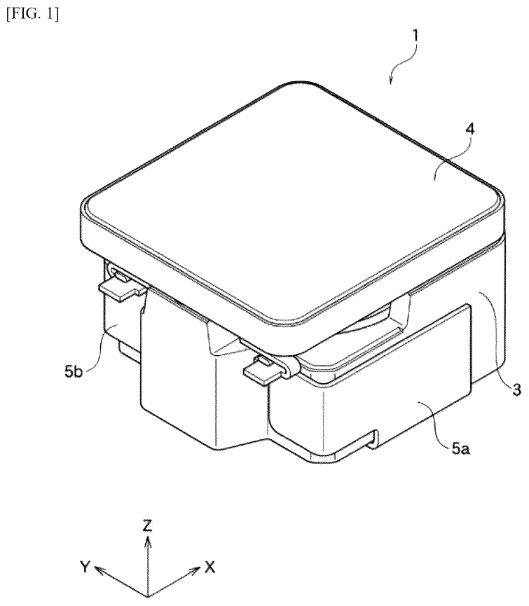

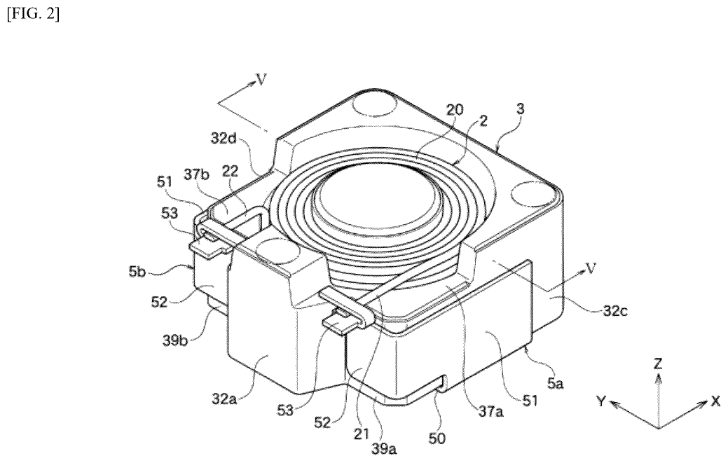

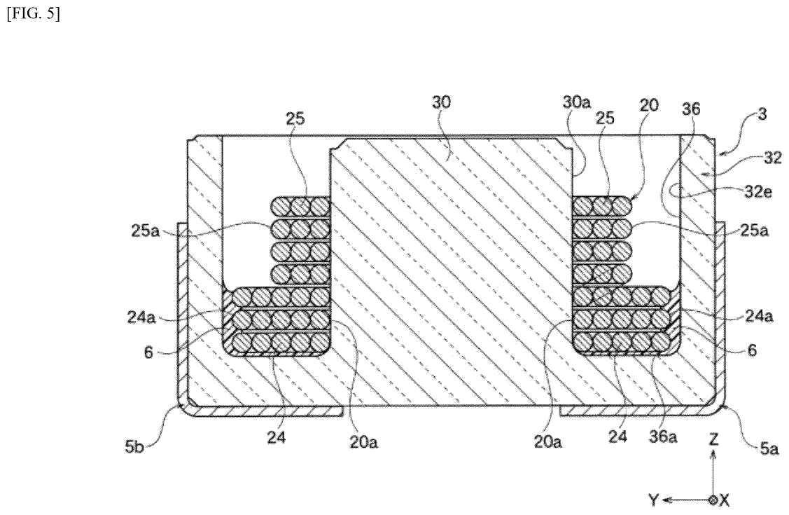

A coil device 1 according to a first embodiment illustrated in FIG. 1 functions as, for example, an inductor, and is mounted in a filter circuit or the like of an electronic device. As illustrated in FIGS. 1 and 2, the coil device 1 includes a wire 2, a first core 3, a second core 4, a terminal 5a, a terminal 5b, and a resin 6 (FIG. 5).

The wire 2 is, for example, an insulation-covered wire, and includes a conductive core wire covered with an insulating coating. The wire 2 is a known winding wire such as polyamideimide copper wire (AIW), polyurethane copper wire (UEW) or polyester copper wire (PEW). The wire 2 is a round wire, but may be a square wire, a stranded wire, a Litz wire, a braided wire, or the like. In addition, the wire 2 may be a self-fusing wire including a fusing layer. The material constituting the wire 2 is not particularly limited, but is, for example, copper, a copper alloy, silver, or nickel. A diameter of the wire 2 is, for example, 10 to 400 μm. The coating is stripped at both end portions of the wire 2 to expose the conductive core wire.

As illustrated in FIG. 2, the wire 2 includes a winding portion 20 and lead-out portions 21 and 22 led out from the winding portion 20. The winding portion 20 is a coreless coil, and is accommodated inside the first core 3. The lead-out portions 21 and 22 are led out in the same direction, but may be led out in different directions (for example, opposite to each other). In addition, the lead-out portions 21 and 22 extend parallel to each other, but may extend non-parallel to each other.

The first core 3 is a so-called pot core. The first core 3 is formed from a material containing a magnetic material and a resin. The magnetic material constituting the first core 3 is not particularly limited, but is, for example, ferrite (Ni—Zn ferrite, Mn—Zn ferrite, or the like) or a metallic magnetic material (Fe—Ni alloy, Fe—Si alloy, Fe—Si—Cr alloy, Fe—Co alloy, Fe—Si—Al alloy, amorphous iron, or the like). The resin constituting the first core 3 is not particularly limited, but is an epoxy resin, a phenolic resin, a polyester resin, a polyurethane resin, a polyimide resin, or the like. The first core 3 may be a sintered body of a metallic magnetic material.

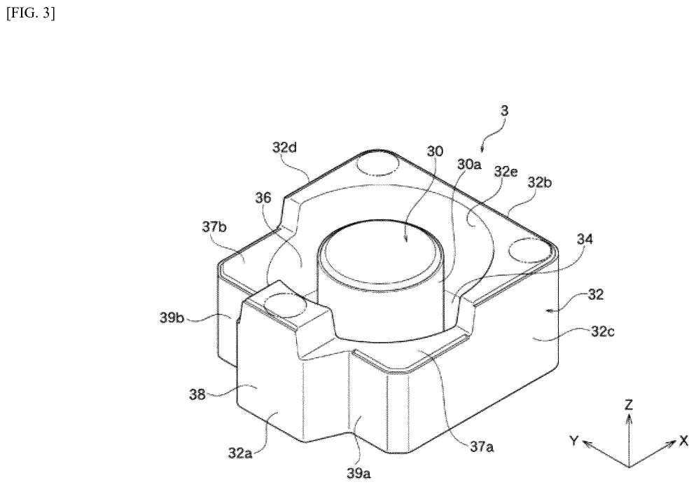

As illustrated in FIG. 3, the first core 3 includes a core portion 30, a side wall portion 32, a bottom wall portion 34, and a recess 36. The bottom wall portion 34 is located at the bottom of the first core 3 having a bottomed cylindrical shape. The core portion 30 has a circular pole shape, and protrudes from the bottom wall portion 34. The shape of the core portion 30 is not limited to a circular pole, and may be, for example, an elliptical pole or a polygonal pole. The core portion 30 penetrates through the inside of the winding portion 20 (FIG. 2).

The recess 36 is located between the core portion 30 and the side wall portion 32. The recess 36 is formed in a ring shape in a plan view. The winding portion 20 is accommodated in the recess 36 (a space between an outer peripheral surface 30a of the core portion 30 and an inner peripheral surface 32e of the side wall portion 32). As will be described later, a resin is applied (filled) to the recess 36.

The side wall portion 32 protrudes from the bottom wall portion 34 to surround the core portion 30 in all directions. The side wall portion 32 is formed in a ring shape. In a plan view, the shape of the inner peripheral surface 32e of the side wall portion 32 is a circular shape. An outer peripheral surface of the side wall portion 32 has a first surface 32a, a second surface 32b, a third surface 32c, and a fourth surface 32d. The second surface 32b, the third surface 32c, and the fourth surface 32d are substantially flat surfaces. Meanwhile, protrusions and recesses are formed on the first surface 32a.

In the plan view of FIG. 3, a ridge portion between the second surface 32b and the third surface 32c is curved; however, the second surface 32b and the third surface 32c may be orthogonal to each other. In addition, in a plan view, a ridge portion between the second surface 32b and the fourth surface 32d is curved; however, the second surface 32b and the fourth surface 32d may be orthogonal to each other. In addition, in a plan view, a ridge portion between the first surface 32a and the third surface 32c is chamfered; however, the first surface 32a and the third surface 32c may be orthogonal to each other. In addition, in a plan view, a ridge portion between the first surface 32a and the fourth surface 32d is chamfered; however, the first surface 32a and the fourth surface 32d may be orthogonal to each other.

Hereinafter, an axis parallel to an axial direction of the core portion 30 is defined as a Z-axis. In addition, an axis perpendicular to the second surface 32b is defined as an X-axis. In addition, an axis perpendicular to the third surface 32c and the fourth surface 32d is defined as a Y-axis. The Y-axis is an axis along a direction in which the third surface 32c and the fourth surface 32d face each other. The X-axis, the Y-axis, and the Z-axis are orthogonal to each other. A length of the coil device 1 in an X-axis direction is not particularly limited, but is, for example, 2 to 20 mm. A length of the coil device 1 in a Y-axis direction is not particularly limited, but is, for example, 2 to 20 mm. A length of the coil device 1 in a Z-axis direction is not particularly limited, but is, for example, 1 to 10 mm.

In the present disclosure, the negative direction side of the X-axis is defined as “forward” or “front”, and the positive direction side of the X-axis is defined as “rearward” or “rear”. In addition, the positive direction side and the negative direction side of the Y-axis are defined as “lateral” or “lateral side”. In addition, the positive direction side of the Z-axis is defined as “upward” or “upper side”, and the negative direction side of the Z-axis is defined as “downward” or “lower side”. However, the upper side in the Z-axis direction does not necessarily coincide with an upper side in a vertical direction. In addition, the lower side in the Z-axis direction does not necessarily coincide with a lower side in the vertical direction. A mounting substrate (not illustrated) for mounting the coil device 1 is disposed below the coil device 1. A winding axis of the winding portion 20 described above is oriented in a direction perpendicular to the mounting substrate.

In addition, in the present disclosure, “equal”, “same”, or “similar” does not only refer to a concept indicating a state where the physical quantities of a plurality of objects being compared are strictly equal, the same, or similar, but the concept of “equal”, “same”, or “similar” also includes a state where an error of ±Δ% (although not particularly limited, for example, Δ=7, 5, or 3) or less occurs between the physical quantities of the plurality of objects being compared.

In addition, in the present disclosure, “parallel” does not only refer to the concept of being strictly parallel, but the concept of “parallel” also includes a state where an error of ±Δθ° (although not particularly limited, for example, Δθ=3) or less occurs with respect to being strictly parallel. In addition, “perpendicular” or “orthogonal” does not only refer to the concept of being strictly perpendicular or orthogonal, but also the concept of “perpendicular” or “orthogonal” also includes a state where an error of ±Δθ° (although not particularly limited, for example, Δθ=3) or less occurs with respect to being strictly perpendicular or orthogonal.

Cutout portions 37a and 37b are formed on an upper surface of the side wall portion 32. When viewed in the X-axis direction, the cutout portion 37a and the cutout portion 37b are spaced apart from each other in the Y-axis direction. The cutout portions 37a and 37b are formed by cutting the upper surface of the side wall portion 32 downward. The cutout portions 37a and 37b extend forward from a central portion of the side wall portion 32 in the X-axis direction. However, the central portion of the side wall portion 32 in the X-axis direction includes not only the exact center of the side wall portion 32 in the X-axis direction, but also a position away from the exact center of the side wall portion 32 in the X-axis direction by ±Δx. Δx is not particularly limited, but is equivalent to, for example, 5% of a length of the side wall portion 32 in the X-axis direction.

The cutout portion 37a or 37b is not particularly limited, but is, for example, ⅕ or more and ½ or less of a height of the side wall portion 32. When viewed in the Y-axis direction, a length (minimum length or maximum length) of the cutout portion 37a or 37b in the X-axis direction is not particularly limited, but is, for example, ¼ or more or ⅓ or more of the length of the side wall portion 32 in the X-axis direction. When viewed in the X-axis direction, a length (minimum length or maximum length) of the cutout portion 37a or 37b in the Y-axis direction is not particularly limited, but is, for example, ¼ or more and less than ½ of the length of the side wall portion 32 in the X-axis direction.

As illustrated in FIG. 2, the lead-out portion 21 is led out forward toward the outside of the side wall portion 32 through the cutout portion 37a. In addition, the lead-out portion 22 is led out forward toward the outside of the side wall portion 32 through the cutout portion 37b.

When viewed in the Y-axis direction, the lead-out portion 21 is exposed to the lateral side (Y-axis negative direction side) through the cutout portion 37a. In addition, when viewed in the Y-axis direction, the lead-out portion 22 is exposed to the lateral side (Y-axis positive direction side) through the cutout portion 37b. In addition, when viewed in the Y-axis direction, the winding portion 20 is exposed to the lateral sides through the cutout portions 37a and 37b.

When viewed in the X-axis direction, the lead-out portion 21 is exposed to the front through the cutout portion 37a. In addition, when viewed in the X-axis direction, the lead-out portion 22 is exposed to the front through the cutout portion 37b. In addition, when viewed in the X-axis direction, the winding portion 20 is exposed to the front through the cutout portions 37a and 37b.

As illustrated in FIG. 3, recesses 39a and 39b are formed on the first surface 32a. When viewed in the X-axis direction, the recess 39a and the recess 39b are spaced apart from each other in the Y-axis direction. The recesses 39a and 39b are recessed toward the rear of the side wall portion 32. As illustrated in FIG. 2, in a plan view, a part of the terminal 5a is disposed in the recess 39a. In addition, in a plan view, a part of the terminal 5b is disposed in the recess 39b.

As illustrated in FIG. 3, a protrusion 38 is formed between the recess 39a and the recess 39b. The protrusion 38 protrudes forward from the bottoms of the recesses 39a and 39b. In the plan view of FIG. 3, a length of the protrusion 38 in the Y-axis direction becomes shorter as the protrusion 38 extends toward the front, and becomes longer as the protrusion 38 extends toward the rear. The length of the protrusion 38 in the Y-axis direction is not particularly limited, but is, for example, ¼ or more or ⅓ or more of a length of the side wall portion 32 in the Y-axis direction. In addition, a length of the protrusion 38 in the X-axis direction (in other words, a depth of the recess 39a or 39b) is not particularly limited, but is, for example, 1/10 or more and ⅓ or less of the length of the side wall portion 32 in the X-axis direction.

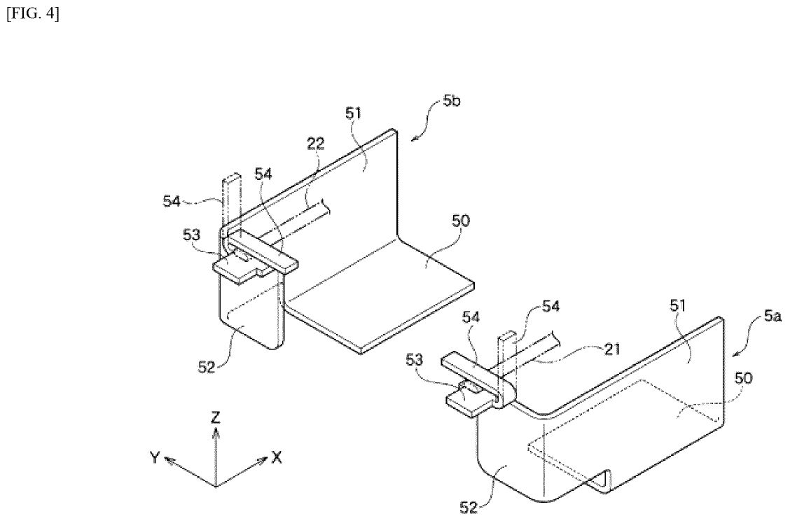

As illustrated in FIG. 4, each of the terminals 5a and 5b includes a mounting portion 50, a first side portion 51, a second side portion 52, a wire connecting portion 53, and a crimping portion 54. The terminals 5a and 5b are made of a plate-shaped conductor such as metal.

As illustrated in FIGS. 2 and 4, the mounting portion 50 is disposed along a bottom surface of the first core 3. The mounting portion 50 is connected to the mounting substrate (not illustrated) by solder, a conductive adhesive, or the like.

The first side portion 51 of the terminal 5a is disposed along the third surface 32c. In addition, the first side portion 51 of the terminal 5b is disposed along the fourth surface 32d. The first side portion 51 is continuous with the mounting portion 50 so as to be orthogonal to the mounting portion 50. A length of the first side portion 51 in the X-axis direction is not particularly limited, but is longer than a length of the mounting portion 50 in the X-axis direction. A fillet of solder, conductive adhesive, or the like is formed on the first side portion 51.

The second side portion 52 is continuous with the first side portion 51 so as to be orthogonal to the first side portion 51. The second side portion 52 is disposed along the first surface 32a. In more detail, the second side portion 52 of the terminal 5a is disposed along the first surface 32a so as to be accommodated in the recess 39a. The second side portion 52 of the terminal 5b is disposed along the first surface 32a so as to be accommodated in the recess 39b.

The wire connecting portion 53 is continuous with the second side portion 52 so as to be orthogonal to the second side portion 52. In the plan view of FIG. 2, at least a part of the wire connecting portion 53 of the terminal 5a is accommodated in the recess 39a. In the plan view of FIG. 2, at least a part of the wire connecting portion 53 of the terminal 5b is accommodated in the recess 39b. The lead-out portion 21 is connected to the wire connecting portion 53 of the terminal 5a. The lead-out portion 22 is connected to the wire connecting portion 53 of the terminal 5b.

The crimping portion 54 is configured to be freely bent with respect to the wire connecting portion 53. The crimping portion 54 of the terminal 5a and the crimping portion 54 of the terminal 5b are not particularly limited, but are bent in a direction toward each other. The crimping portion 54 of the terminal 5a clamps the lead-out portion 21 that is led out to the wire connecting portion 53 of the terminal 5a. The crimping portion 54 of the terminal 5b clamps the lead-out portion 22 that is led out to the wire connecting portion 53 of the terminal 5b. The lead-out portions 21 and 22 are connected to the wire connecting portions 53 of the terminals 5a and 5b, for example, by laser welding, soldering, a conductive adhesive, thermocompression bonding, ultrasonic bonding, resistance brazing, or ultraviolet curable resin bonding. When laser welding is performed on the wire connecting portion 53, a weld bead is formed on the wire connecting portion 53.

As illustrated in FIG. 1, the second core 4 is a plate-shaped core that is flat in the Z-axis direction. The material constituting the second core 4 is the same as the material constituting the first core 3, but may be different. The second core 4 is bonded to the upper surface of the side wall portion 32 illustrated in FIG. 2, for example, by an adhesive. In FIG. 2, adhesive application regions are indicated by two-dot chain lines, but the adhesive application regions are not limited to regions illustrated in FIG. 2.

As illustrated in FIG. 5, the winding portion 20 includes a dense portion 24 and a sparse portion 25. The dense portion 24 has a relatively large number of layers along a radial direction of the core portion 30 (here, a plurality of layers along the radial direction of the core portion 30). The sparse portion 25 has a relatively small number of layers along the radial direction of the core portion 30 (here, a plurality of layers along the radial direction of the core portion 30). The number of layers of the dense portion 24 along the radial direction of the core portion 30 is larger than the number of layers of the sparse portion 25 along the radial direction of the core portion 30. The number of layers of the dense portion 24 and the number of layers of the sparse portion 25 along the radial direction of the core portion 30 are both odd numbers, but at least one may be an even number. In an example illustrated in FIG. 5, the number of layers of the dense portion 24 along the radial direction of the core portion 30 is five, and the number of layers of the sparse portion 25 along the radial direction of the core portion 30 is three. However, the number of layers of the dense portion 24 and the number of layers of the sparse portion 25 along the radial direction of the core portion 30 are not particularly limited, and for example, the number of layers of the dense portion 24 along the radial direction of the core portion 30 may be four (an even number of layers), and the number of layers of the sparse portion 25 along the radial direction of the core portion 30 may be three (an odd number of layers).

The dense portion 24 is not particularly limited, but is formed of three layers along the axial direction of the core portion 30. The sparse portion 25 is not particularly limited, but is formed of four layers along the axial direction of the core portion 30. The number of layers of the dense portion 24 along the axial direction of the core portion 30 is smaller than the number of layers of the sparse portion 25 along the axial direction of the core portion 30, but may be the same or larger.

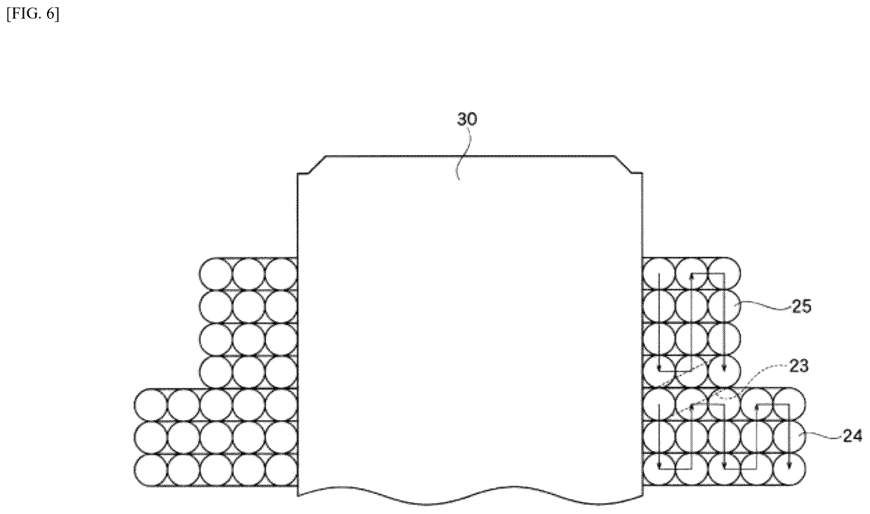

In the present embodiment, the dense portion 24 is closer to the bottom (bottom surface 36a) of the recess 36 than the sparse portion 25. Namely, the dense portion 24 is located below the sparse portion 25. As illustrated in FIG. 6, the dense portion 24 and the sparse portion 25 are continuously connected by a connecting portion 23. The connecting portion 23 extends obliquely from an outermost layer (third layer) of the sparse portion 25 in the radial direction to an innermost layer (first layer) of the dense portion 24 in the radial direction.

The wire 2 is wound in the sparse portion 25 so as to reciprocate in an up-down direction as indicated by arrows in FIG. 6. In addition, the wire 2 is wound in the dense portion 24 so as to reciprocate in the up-down direction. Namely, in the present embodiment, first, the wire 2 is wound to form the sparse portion 25, and thereafter, the wire 2 is wound to form the dense portion 24.

After the outermost layer of the sparse portion 25 in the radial direction is formed, the wire 2 is led out to the innermost layer of the dense portion 24 in the radial direction. The lead-out portion of the wire 2 is the connecting portion 23. The method for winding the wire 2 is not limited to the above-described method. For example, the wire 2 may be wound up to a third layer of the winding portion 20 in the radial direction without distinguishing between the dense portion 24 and the sparse portion 25. Furthermore, the wire 2 may be wound such that the dense portion 24 is formed from a fourth layer to a fifth layer of the winding portion 20 in the radial direction.

As illustrated in FIG. 5, the winding portion 20 (the dense portion 24 and the sparse portion 25) is in contact with the outer peripheral surface 30a of the core portion 30. More specifically, an inner peripheral surface 20a of the winding portion 20 is in contact with the outer peripheral surface 30a of the core portion 30. However, the winding portion 20 may not be in contact with the outer peripheral surface 30a of the core portion 30, and a gap may be formed between the inner peripheral surface 20a of the winding portion 20 and the outer peripheral surface 30a of the core portion 30.

The dense portion 24 is not in contact with the side wall portion 32 and the bottom (bottom surface 36a) of the recess 36. In addition, the sparse portion 25 is not in contact with the side wall portion 32. More specifically, an outer peripheral surface 24a of the dense portion 24 is not in contact with the inner peripheral surface 32e of the side wall portion 32. In addition, the bottom (bottom surface) of the dense portion 24 is not in contact with the bottom surface 36a of the recess 36. In addition, an outer peripheral surface 25a of the sparse portion 25 is not in contact with the inner peripheral surface 32e of the side wall portion 32. However, the bottom of the dense portion 24 may be in contact with the bottom surface 36a of the recess 36.

The resin 6 is applied (filled) to the recess 36, and the resin 6 adheres to the winding portion 20. The resin 6 is not particularly limited, but is, for example, an epoxy resin. The resin 6 adheres to the outer peripheral surface 24a of the dense portion 24, and covers the outer peripheral surface 24a. The resin 6 enters a gap between the outer peripheral surface 24a of the dense portion 24 and the inner peripheral surface 32e of the side wall portion 32, and bonds (connects) the dense portion 24 (the outer peripheral surface 24a of the dense portion 24) and the side wall portion 32 (the inner peripheral surface 32e of the side wall portion 32). In the example illustrated in FIG. 5, a width of the gap between the outer peripheral surface 24a of the dense portion 24 and the inner peripheral surface 32e of the side wall portion 32 is narrower than a diameter of the wire 2. However, the width of the gap between the outer peripheral surface 24a of the dense portion 24 and the inner peripheral surface 32e of the side wall portion 32 may be equal to the diameter of the wire 2, or may be wider than the diameter of the wire 2. The resin 6 may bond the dense portion 24 and the side wall portion 32 in all directions in the plan view of FIG. 5. Alternatively, the resin 6 may locally bond the dense portion 24 and the side wall portion 32 in the plan view of FIG. 5. The resin 6 adheres to the outer peripheral surface 24a of the dense portion 24, but a part of the resin 6 may enter the inside of the dense portion 24. For example, the resin 6 may adhere not only to the fifth layer of the dense portion 24 in the radial direction, but also to at least one of the first to fourth layers of the dense portion 24 in the radial direction. In addition, the dense portion 24 may be entirely immersed in the resin 6.

Filling may be performed with the resin 6 without any gaps between the outer peripheral surface 24a of the dense portion 24 and the inner peripheral surface 32e of the side wall portion 32. Alternatively, filling may be performed with the resin 6 such that a gap is formed between the outer peripheral surface 24a of the dense portion 24 and the inner peripheral surface 32e of the side wall portion 32.

Filling is performed with the resin 6 between the dense portion 24 and the side wall portion 32 from the bottom surface 36a of the recess 36 to a third layer of the dense portion 24 in the Z-axis direction. However, filling may be performed with the resin 6 between the dense portion 24 and the side wall portion 32 from the bottom surface 36a of the recess 36 to a second layer of the dense portion 24 in the Z-axis direction without covering the third layer of the dense portion 24 in the Z-axis direction. In addition, filling may be performed with the resin 6 between the dense portion 24 and the side wall portion 32 from the bottom surface 36a of the recess 36 to a first layer of the dense portion 24 in the Z-axis direction without covering the second layer and the third layer of the dense portion 24 in the Z-axis direction.

A gap between the dense portion 24 and the bottom (bottom surface 36a) of the recess 36 is also filled with the resin 6. The resin 6 bonds (connects) the dense portion 24 (the bottom surface of the dense portion 24) and the bottom surface 36a of the recess 36. Filling may be performed with the resin 6 without any gaps between the dense portion 24 and the bottom surface 36a of the recess 36, or may be performed such that a gap is formed. The resin 6 between the dense portion 24 and the bottom surface 36a is bonded to the resin 6 between the dense portion 24 and the side wall portion 32. However, the resin 6 between the dense portion 24 and the bottom surface 36a and the resin 6 between the dense portion 24 and the side wall portion 32 may be discontinuous with each other. The gap between the dense portion 24 and the bottom of the recess 36 may not be filled with the resin 6. In addition, when the gap between the dense portion 24 and the bottom of the recess 36 is filled with the resin 6, the resin 6 may not bond the dense portion 24 and the bottom of the recess 36.

A thickness of the resin 6 between the dense portion 24 and the side wall portion 32 (here, a thickness along the radial direction of the dense portion 24) is thicker than a thickness of the resin 6 between the dense portion 24 and the bottom (bottom surface 36a) of the recess 36 (here, a thickness along the Z-axis direction of the dense portion 24). However, the thickness of the resin 6 between the dense portion 24 and the side wall portion 32 may be equal to the thickness of the resin 6 between the dense portion 24 and the bottom (bottom surface 36a) of the recess 36, or may be thinner.

In the example illustrated in FIG. 5, the resin 6 does not adhere to an upper surface of the dense portion 24, but may adhere to the upper surface of the dense portion 24. In addition, the resin 6 adhered to the upper surface of the dense portion 24 may be connected to the resin 6 between the dense portion 24 and the side wall portion 32.

The resin 6 bonds the dense portion 24 and the side wall portion 32 without bonding (connecting) the sparse portion 25 (the outer peripheral surface 25a of the sparse portion 25) and the side wall portion 32 (the inner peripheral surface 32e of the side wall portion 32). Therefore, a gap is formed between the outer peripheral surface 25a of the sparse portion 25 and the inner peripheral surface 32e of the side wall portion 32. In the example illustrated in FIG. 5, the resin 6 does not adhere to the outer peripheral surface 25a of the sparse portion 25. However, the resin 6 may adhere to at least a part of the outer peripheral surface 25a of the sparse portion 25 as long as the resin 6 does not bond the sparse portion 25 and the side wall portion 32. In this case, the resin 6 adhered to the outer peripheral surface 25a of the sparse portion 25 may be connected to the resin 6 between the dense portion 24 and the side wall portion 32.

The resin 6 does not bond (connect) the core portion 30 and the winding portion 20 (the dense portion 24 and the sparse portion 25). The reason is that the outer peripheral surface 30a of the core portion 30 and the inner peripheral surface 20a of the winding portion 20 (the inner peripheral surface of the dense portion 24 and the inner peripheral surface of the sparse portion 25) are in contact with each other and the resin 6 does not enter between the outer peripheral surface 30a of the core portion 30 and the inner peripheral surface 20a of the winding portion 20. However, the resin 6 may slightly enter between the outer peripheral surface 30a of the core portion 30 and the inner peripheral surface 20a of the winding portion 20 (the inner peripheral surface of the dense portion 24 and/or the inner peripheral surface of the sparse portion 25).

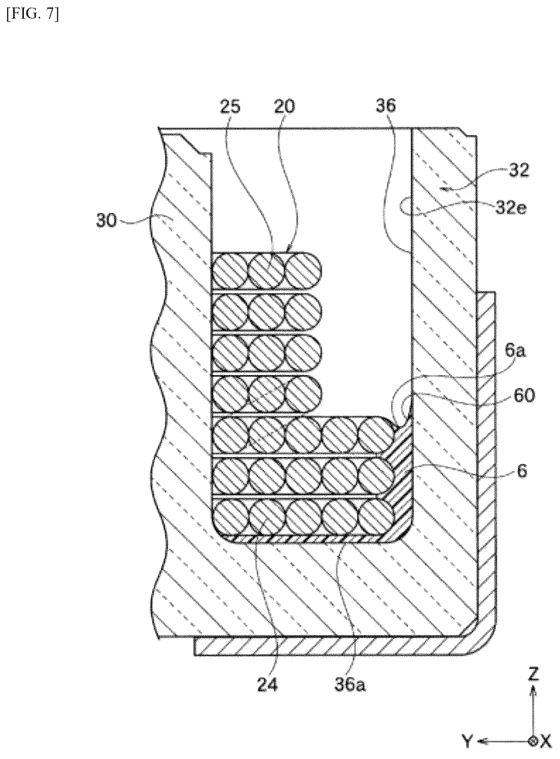

As illustrated in FIG. 7, a recess 60 is formed on a surface 6a of the resin 6. The recess 60 is recessed toward the bottom of the recess 36 between the dense portion 24 and the side wall portion 32. The bottom of the recess 60 is not particularly limited, but is located lower than the upper surface of the dense portion 24.

The surface 6a of the resin 6 rises as the surface 6a approaches the dense portion 24 and the side wall portion 32. Namely, the surface 6a of the resin 6 is inclined upward as the surface 6a approaches the dense portion 24, and is inclined upward as the surface 6a approaches the side wall portion 32. However, the surface 6a of the resin 6 may be a flat surface parallel to the bottom surface 36a of the recess 36. Alternatively, the surface 6a of the resin 6 may be an inclined surface as a whole that is inclined upward as the surface 6a approaches the side wall portion 32.

The surface 6a of the resin 6 is raised more in the vicinity of the side wall portion 32 than in the vicinity of the dense portion 24. The surface 6a of the resin 6 is not particularly limited, but is located higher than the upper surface of the dense portion 24 in the vicinity of the side wall portion 32.

Next, a method for manufacturing the coil device 1 will be described. First, the wire 2 including the winding portion 20 illustrated in FIGS. 1 and 2, the first core 3, the second core 4, the terminal 5a, and the terminal 5b are prepared. Here, as illustrated in FIG. 5, the winding portion 20 includes the dense portion 24 having a relatively large number of layers along the radial direction of the winding portion 20, and the sparse portion 25 having a relatively small number of layers along the radial direction of the winding portion 20. In addition, the first core 3 includes the core portion 30 having a columnar shape; the side wall portion 32 surrounding the core portion 30; and the recess 36 located between the core portion 30 and the side wall portion 32.

Next, as illustrated in FIG. 2, the terminals 5a and 5b are bonded to an outer peripheral surface of the first core 3, for example, by an adhesive. Next, as illustrated in FIG. 5, a predetermined amount of the resin 6 is applied (filled) to the recess 36 (for example, the bottom surface 36a of the recess 36 or the inner peripheral surface 32e of the side wall portion 32), and thereafter, the winding portion 20 is accommodated in the recess 36. Then, the resin 6 is allowed to enter between the dense portion 24 (the outer peripheral surface 24a of the dense portion 24) and the side wall portion 32 (the inner peripheral surface 32e of the side wall portion 32). Accordingly, the resin 6 bonds the dense portion 24 to the side wall portion 32, and bonds the dense portion 24 and the bottom of the recess 36. The winding portion 20 may be accommodated in the recess 36, and thereafter, a predetermined amount of the resin 6 may be applied (filled) to the recess 36 (for example, the bottom surface 36a of the recess 36 or the inner peripheral surface 32e of the side wall portion 32).

Next, as illustrated in FIG. 4, the lead-out portion 21 is clamped by the crimping portion 54 of the terminal 5a, and for example, the lead-out portion 21, the wire connecting portion 53, and the crimping portion 54 are welded together. In addition, the lead-out portion 22 is clamped by the crimping portion 54 of the terminal 5b, and for example, the lead-out portion 22, the wire connecting portion 53, and the crimping portion 54 are welded together.

Next, as illustrated in FIGS. 1 and 2, the second core 4 is bonded to the upper surface of the side wall portion 32, for example, by an adhesive. As described above, the coil device 1 illustrated in FIG. 1 can be manufactured.

As illustrated in FIG. 5, in the coil device 1 of the present embodiment, the winding portion 20 includes the dense portion 24 having a relatively large number of layers along the radial direction of the winding portion 20, and the sparse portion 25 having a relatively small number of layers along the radial direction of the winding portion 20. Furthermore, the resin 6 bonds the dense portion 24 to the side wall portion 32 without bonding the sparse portion 25 and the side wall portion 32. By forming the dense portion 24 in the winding portion 20, the distance between the dense portion 24 and the side wall portion 32 is made relatively short, and the dense portion 24 and the side wall portion 32 are easily bonded by the resin 6. Heat generated in the winding portion 20 can be dissipated via the resin 6 by bonding the dense portion 24 and the side wall portion 32 using the resin 6. Particularly, since the dense portion 24 is more likely to generate heat than the sparse portion 25, heat generated in the winding portion 20 can be efficiently dissipated via the resin 6 by bonding the dense portion 24 and the side wall portion 32 using the resin 6. In addition, since the recess 36 is filled (applied) with a predetermined amount of the resin 6 such that the dense portion 24 and the side wall portion 32 are bonded by the resin 6, the amount of the resin 6 with which the recess 36 is filled is less likely to vary. In addition, by always filling the recess 36 with the resin 6 such that, for example, the filling of the resin 6 reaches the vicinity of the upper surface of the dense portion 24, a variation in the amount of the resin 6 with which the recess 36 is filled can be effectively prevented. Accordingly, the amount of heat dissipation from the winding portion 20 is less likely to vary, and an increase in the temperature of the winding portion 20 can be effectively prevented.

In addition, the resin 6 does not bond the sparse portion 25 and the side wall portion 32. Namely, the resin 6 does not cover the entirety of the winding portion 20, and does not bond the entire outer peripheral surface of the winding portion 20 and the inner peripheral surface 32e of the side wall portion 32. Therefore, when the temperature changes, stress caused by a difference in thermal expansion coefficient between the winding portion 20, the resin 6, and the first core 3 (stress caused by the expansion and contraction of the resin 6 or thermal load) is less likely to be generated, and fluctuations in the inductance of the coil device 1 can be prevented.

In addition, the resin 6 bonds the outer peripheral surface 24a of the dense portion 24 and the inner peripheral surface 32e of the side wall portion 32. Therefore, a heat dissipation path for dissipating heat from the dense portion 24 can be formed between the outer peripheral surface 24a of the dense portion 24 and the inner peripheral surface 32e of the side wall portion 32. Accordingly, heat from the dense portion 24 that is likely to generate heat can be efficiently dissipated toward the side wall portion 32 via the resin 6.

In addition, the resin 6 further bonds the bottom surface of the dense portion 24 and the bottom of the recess 36. Therefore, a heat dissipation path for dissipating heat from the dense portion 24 can be further formed between the bottom surface of the dense portion 24 and the bottom of the recess 36. Accordingly, heat from the dense portion 24 that is likely to generate heat can be efficiently dissipated toward the side wall portion 32 via the resin 6.

In addition, the dense portion 24 is closer to the bottom of the recess 36 than the sparse portion 25. Therefore, the dense portion 24 can be bonded to the bottom of the recess 36 by the resin 6. Accordingly, heat generated in the winding portion 20 can be efficiently dissipated. In addition, the amount of the resin 6 between the dense portion 24 and the side wall portion 32 can be visually confirmed through an opening of the recess 36. Accordingly, it can be determined whether the amount of the resin 6 between the dense portion 24 and the side wall portion 32 is appropriate (constant).

In addition, as illustrated in FIG. 7, in a cross-section parallel to the axial direction of the core portion 30, the surface 6a of the resin 6 is recessed toward the bottom of the recess 36 between the dense portion 24 and the side wall portion 32, and rises as the surface 6a approaches the dense portion 24 and the side wall portion 32. The surface 6a of the resin 6 rises as the surface 6a approaches the dense portion 24, so that the adhesion strength between the resin 6 and the dense portion 24 can be increased. In addition, the surface 6a of the resin 6 rises as the surface 6a approaches the side wall portion 32, so that the adhesion strength between the resin 6 and the side wall portion 32 can be increased. Accordingly, the winding portion 20 is easily and firmly fixed to the side wall portion 32 via the resin 6. Therefore, the position of the winding portion 20 can be stabilized, and a variation in the inductance characteristics of the coil device 1 can be prevented.

In addition, the surface 6a of the resin 6 is raised more in the vicinity of the side wall portion 32 than in the vicinity of the dense portion 24. Accordingly, the adhesion strength between the resin 6 and the side wall portion 32 can be further increased. Therefore, the position of the winding portion 20 can be stabilized, and a variation in the inductance characteristics of the coil device 1 can be effectively prevented.

In addition, the resin 6 does not bond the core portion 30 and the dense portion 24. Therefore, stress caused by the expansion and contraction of the resin 6 is less likely to be generated, and fluctuations in the inductance of the coil device 1 can be prevented.

In addition, the dense portion 24 is in contact with the core portion 30 whereas the dense portion 24 is not in contact with the side wall portion 32 and the bottom of the recess 36. By bringing the dense portion 24 into contact with the core portion 30, the position of the winding portion 20 can be stabilized, and fluctuations in the inductance of the coil device 1 can be prevented. In addition, when the dense portion 24 is not in contact with the side wall portion 32 and the bottom of the recess 36, the resin 6 easily enters between the dense portion 24 and the side wall portion 32. In addition, the resin 6 easily enters between the dense portion 24 and the bottom of the recess 36. Accordingly, heat generated in the winding portion 20 can be efficiently dissipated via the resin 6.

In addition, the method for manufacturing the coil device 1 of the present embodiment includes a step of applying (filling) the resin 6 to the recess 36. Furthermore, the method for manufacturing the coil device 1 of the present embodiment includes a step of accommodating the winding portion 20 in the recess 36 and allowing the resin 6 to enter between the dense portion 24 and the side wall portion 32. Therefore, the resin 6 that has entered between the dense portion 24 and the side wall portion 32 can bond the dense portion 24 and the side wall portion 32. In this case, since the recess 36 is filled with a predetermined amount of the resin 6 such that the dense portion 24 and the side wall portion 32 are bonded by the resin 6, the amount of the resin 6 with which the recess 36 is filled is less likely to vary. In addition, by always filling the recess 36 with the resin 6 such that, for example, the filling of the resin 6 reaches the vicinity of the upper surface of the dense portion 24, a variation in the amount of the resin 6 with which the recess 36 is filled can be effectively prevented. Accordingly, the amount of heat dissipation from the winding portion 20 is less likely to vary, and an increase in the temperature of the winding portion 20 can be effectively prevented.

### Second Embodiment

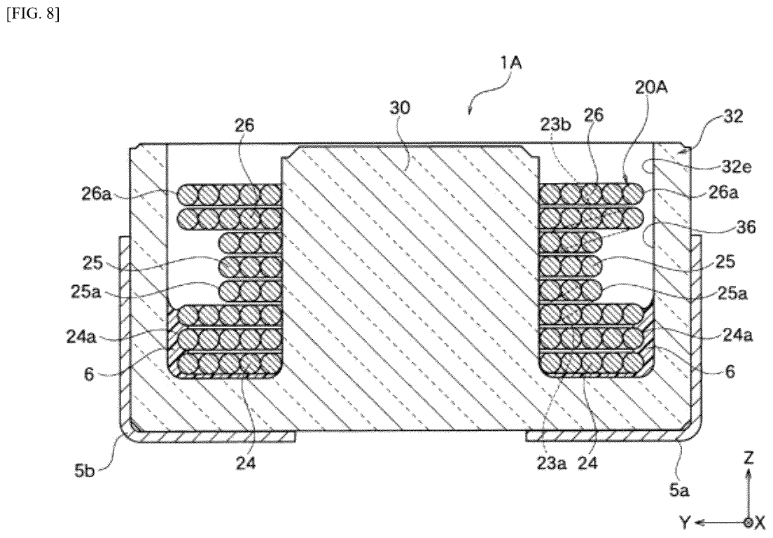

A coil device 1A of a second embodiment illustrated in FIG. 8 has a configuration similar to that of the coil device 1 of the first embodiment, except for the following points. Portions that overlap with the coil device 1 of the first embodiment are denoted by the same reference numerals, and detailed descriptions thereof will be omitted.

The coil device 1A includes a winding portion 20A. The winding portion 20A includes a dense portion 26 in addition to the dense portion 24 and the sparse portion 25. Namely, the dense portion of the present embodiment has two dense portions. The number of layers of the dense portion 26 along the radial direction of the core portion 30 is equal to the number of layers of the dense portion 24 along the radial direction of the core portion 30, but may be larger than the number of layers of the dense portion 24 along the radial direction of the core portion 30, or may be smaller than the number of layers of the dense portion 24 along the radial direction of the core portion 30. The dense portion 24 is located below the dense portion 26, and is closer to the bottom of the recess 36 than the dense portion 26. The sparse portion 25 is located between the dense portion 24 and the dense portion 26 along the axial direction of the core portion 30. The number of layers of the sparse portion 25 along the axial direction of the core portion 30 is not particularly limited, but is three. The dense portion 24 and the sparse portion 25 are continuously connected by a connecting portion 23a. The dense portion 26 and the sparse portion 25 are continuously connected by a connecting portion 23b.

The resin 6 bonds (connects) the dense portion 24 (the outer peripheral surface 24a of the dense portion 24) and the side wall portion 32 (the inner peripheral surface 32e of the side wall portion 32). In addition, the resin 6 bonds (connects) the dense portion 24 (the bottom of the dense portion 24) and the bottom of the recess 36. The resin 6 between the dense portion 24 and the side wall portion 32 is connected to the resin 6 between the dense portion 24 and the bottom of the recess 36. However, a gap between the dense portion 24 and the bottom of the recess 36 may not be filled with the resin 6. In addition, when the gap between the dense portion 24 and the bottom of the recess 36 is filled with the resin 6, the resin 6 may not bond the dense portion 24 and the bottom of the recess 36.

The resin 6 does not bond (connect) the dense portion 26 (an outer peripheral surface 26a of the dense portion 26) and the side wall portion 32 (the inner peripheral surface 32e of the side wall portion 32). In addition, the resin 6 does not bond the sparse portion 25 (the outer peripheral surface 25a of the sparse portion 25) and the side wall portion 32 (the inner peripheral surface 32e of the side wall portion 32). However, the resin 6 may adhere to the outer peripheral surface 25a of the sparse portion 25. In addition, the resin 6 may adhere to the outer peripheral surface 26a of the dense portion 26. In this case, the resin 6 adhered to the outer peripheral surface 25a and/or 26a may be connected to the resin 6 between the dense portion 24 and the side wall portion 32. In addition, the resin 6 may bond the dense portion 26 (the outer peripheral surface 26a of the dense portion 26) and the side wall portion 32 (the inner peripheral surface 32e of the side wall portion 32).

In the present embodiment, the coil device 1A illustrated in FIG. 8 can be manufactured by a manufacturing method similar to that of the first embodiment, except for a method for forming the winding portion 20A. Namely, in the present embodiment, in forming the winding portion 20A, first, the dense portion 26 is formed by winding the wire 2 so as to reciprocate in the up-down direction (refer to arrows in FIG. 6). Next, the wire 2 is led out from an outermost layer of the dense portion 26 (the outermost layer of the dense portion 26 along the radial direction of the core portion 30) to an innermost layer of the sparse portion 25 (the innermost layer of the sparse portion 25 along the radial direction of the core portion 30). The lead-out portion of the wire 2 becomes the connecting portion 23b described above. Then, the sparse portion 25 is formed by further winding the wire 2 so as to reciprocate in the up-down direction (refer to arrows in FIG. 6). Next, the wire 2 is led out from the outermost layer of the sparse portion 25 (the outermost layer of the sparse portion 25 along the radial direction of the core portion 30) to the innermost layer of the dense portion 24 (the innermost layer of the dense portion 24 along the radial direction of the core portion 30). The lead-out portion of the wire 2 becomes the connecting portion 23a described above. Then, the dense portion 24 is formed by further winding the wire 2 so as to reciprocate in the up-down direction (refer to arrows in FIG. 6).

In the present embodiment as well, effects similar to those of the first embodiment can be obtained. In addition, in the present embodiment, the dense portion of the winding portion 20A includes the dense portion 26 and the dense portion 24 closer to the bottom of the recess 36 than the dense portion 26. In addition, the sparse portion 25 is located between the dense portion 24 and the dense portion 26 along the axial direction of the core portion 30. Furthermore, the resin 6 bonds the dense portion 24 and the side wall portion 32. By forming the dense portion 24, the dense portion 26, and the sparse portion 25 in the winding portion 20A, the inter-winding stray capacitance is reduced between the dense portion 24 and the sparse portions 25, and the inter-winding stray capacitance is reduced between the dense portion 26 and the sparse portions 25. Accordingly, the broadbanding of the frequency characteristics of the impedance of the coil device 1A can be achieved. In addition, since the recess 36 is filled with a predetermined amount of the resin 6 such that the dense portion 24 and the side wall portion 32 are bonded by the resin 6, the amount of the resin 6 with which the recess 36 is filled is less likely to vary. In addition, by always filling the recess 36 with the resin 6 such that, for example, the filling of the resin 6 reaches the vicinity of the upper surface of the dense portion 24, a variation in the amount of the resin 6 with which the recess 36 is filled can be effectively prevented. Accordingly, the amount of heat dissipation from the winding portion 20A is less likely to vary, and an increase in the temperature of the winding portion 20A can be effectively prevented.

In addition, the resin 6 bonds the dense portion 24 and the side wall portion 32 without bonding the dense portion 26 and the side wall portion 32 and without bonding the sparse portion 25 and the side wall portion 32. Therefore, the amount of the resin 6 between the dense portion 24 and the side wall portion 32 can be visually confirmed through the opening of the recess 36. Accordingly, it can be determined whether the amount of the resin 6 between the dense portion 24 and the side wall portion 32 is an appropriate amount (constant amount).

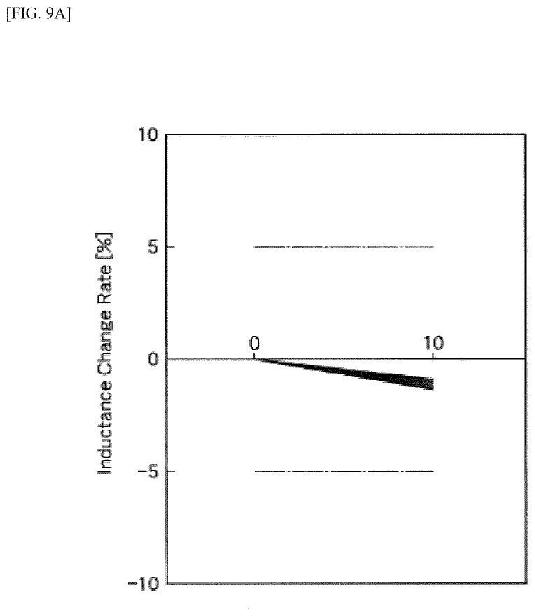

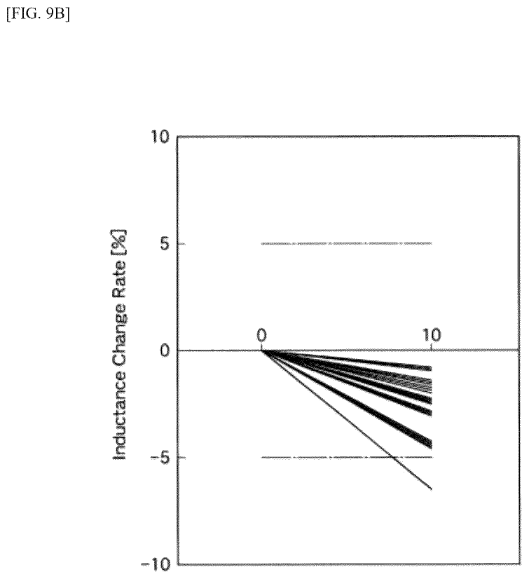

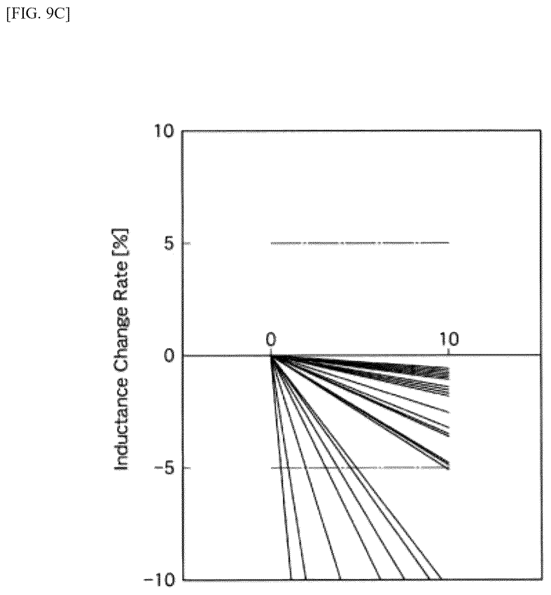

Here, the results of measuring a change rate in inductance characteristics under the following conditions (i) to (iii) using the coil device 1A illustrated in FIG. 8 are illustrated in FIGS. 9A to 9C. The measurement of the change rate in inductance characteristics was performed by placing the mounting substrate, on which the coil device 1A was mounted, into and taking the mounting substrate out of a furnace at a reflow temperature of 260° C. ten times. The number of samples in the coil device 1A is 24. In FIGS. 9A to 9C, the vertical axis represents the change rate in inductance characteristics, and the horizontal axis represents the number of times the mounting substrate passes through the furnace. However, the number of times the mounting substrate passes through the furnace is only two, namely, 0 times and 10 times.
(i) As illustrated in FIG. 8, when the resin 6 bonds only the dense portion 24 and the side wall portion 32.
(ii) Unlike an example illustrated in FIG. 8, when the resin 6 bonds the dense portion 24 and the side wall portion 32 and further bonds the sparse portion 25 and the side wall portion 32.
(iii) Unlike the example illustrated in FIG. 8, when the resin 6 bonds the dense portion 24 and the side wall portion 32, further bonds the sparse portion 25 and the side wall portion 32, and further bonds the dense portion 26 and the side wall portion 32.

When the resin 6 bonded only the dense portion 24 and the side wall portion 32, as illustrated in FIG. 9A, in all the samples, the inductance change rates did not fall outside of a standard value of ±5%. Meanwhile, when the resin 6 bonded the dense portion 24 and the side wall portion 32 and further bonded the sparse portion 25 and the side wall portion 32, as illustrated in FIG. 9B, only one sample in which the change rate in inductance characteristics fell outside of the standard value was confirmed. In addition, when the resin 6 bonded the dense portion 24 and the side wall portion 32, further bonded the sparse portion 25 and the side wall portion 32, and further bonded the dense portion 26 and the side wall portion 32, as illustrated in FIG. 9C, eight samples in which the change rate in inductance characteristics fell outside of the standard value were confirmed. From the above, it was confirmed that fluctuations in the inductance characteristics of the coil device 1A could be effectively prevented by bonding only the dense portion 24 and the side wall portion 32 using the resin 6.

### Third Embodiment

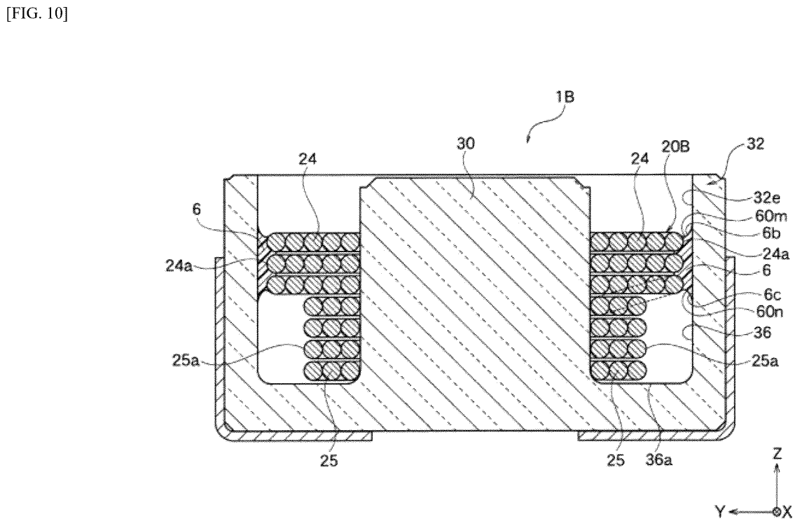

A coil device 1B of a third embodiment illustrated in FIG. 10 has a configuration similar to that of the coil device 1 of the first embodiment, except for the following points. Portions that overlap with the coil device 1 of the first embodiment are denoted by the same reference numerals, and detailed descriptions thereof will be omitted.

The coil device 1B includes a winding portion 20B. The winding portion 20B differs from the winding portion 20 of the first embodiment in that the sparse portion 25 is close to the bottom of the recess 36. Namely, in the present embodiment, the positions of the dense portions 24 and the sparse portion 25 are switched in the up-down direction.

The resin 6 bonds (connects) the dense portion 24 and the side wall portion 32 without bonding (connecting) the sparse portion 25 and the side wall portion 32. The resin 6 may enter the inside of the dense portion 24. In addition, the resin 6 may adhere to the upper surface and/or a lower surface of the dense portion 24. In addition, the resin 6 may adhere to the outer peripheral surface 25a of the sparse portion 25. In this case, the resin 6 adhered to the outer peripheral surface 25a may be connected to the resin 6 between the dense portion 24 and the side wall portion 32.

A recess 60m is formed on an upper surface 6b of the resin 6. The recess 60m is recessed toward the bottom of the recess 36 between the dense portion 24 and the side wall portion 32. The bottom of the recess 60m is not particularly limited, but is located lower than the upper surface of the dense portion 24.

The upper surface 6b of the resin 6 rises as the upper surface 6b approaches the dense portion 24 and the side wall portion 32. Namely, the upper surface 6b is inclined upward as the upper surface 6b approaches the dense portion 24, and is inclined upward as the upper surface 6b approaches the side wall portion 32. However, the upper surface 6b may be a flat surface parallel to the bottom surface 36a of the recess 36.

The upper surface 6b of the resin 6 is raised more in the vicinity of the side wall portion 32 than in the vicinity of the dense portion 24. The upper surface 6b is not particularly limited, but is located higher than the upper surface of the dense portion 24 in the vicinity of the side wall portion 32.

A recess 60n is formed on a lower surface 6c of the resin 6. The recess 60n is recessed toward the opening of the recess 36 between the dense portion 24 and the side wall portion 32. The bottom of the recess 60n is not particularly limited, but is located higher than the lower surface of the dense portion 24.

The lower surface 6c of the resin 6 rises as the lower surface 6c approaches the dense portion 24 and the side wall portion 32. Namely, the lower surface 6c is inclined downward as the lower surface 6c approaches the dense portion 24, and is inclined downward as the lower surface 6c approaches the side wall portion 32. However, the lower surface 6c may be a flat surface parallel to the bottom surface 36a of the recess 36.

The lower surface 6c of the resin 6 is raised more in the vicinity of the side wall portion 32 than in the vicinity of the dense portion 24. The lower surface 6c is not particularly limited, but is located lower than the lower surface of the dense portion 24 in the vicinity of the side wall portion 32.

In the present embodiment, the coil device 1B illustrated in FIG. 9B can be manufactured by a manufacturing method similar to that of the first embodiment, except for a method for forming the winding portion 20B and a method for applying the resin 6. Namely, in the present embodiment, in forming the winding portion 20B, first, the dense portion 24 is formed by winding the wire 2 so as to reciprocate in the up-down direction (refer to arrows in FIG. 6). Next, the wire 2 is led out from an outermost layer of the dense portion 24 (the outermost layer of the dense portion 24 along the radial direction of the core portion 30) to the innermost layer of the sparse portion 25 (the innermost layer of the sparse portion 25 along the radial direction of the core portion 30). The lead-out portion of the wire 2 becomes the connecting portion 23a described above. Then, the sparse portion 25 is formed by further winding the wire 2 so as to reciprocate in the up-down direction (refer to arrows in FIG. 6). Accordingly, the winding portion 20B can be formed.

In addition, in the present embodiment, unlike the first embodiment, the resin 6 is not applied to the bottom surface 36a of the recess 36, but the resin 6 is applied to the inner peripheral surface 32e of the side wall portion 32 (particularly, the position of the inner peripheral surface 32e, which faces the outer peripheral surface 24a of the dense portion 24). Thereafter, the winding portion 20B is accommodated in the recess 36. Then, the resin 6 is allowed to enter between the dense portion 24 (the outer peripheral surface 24a of the dense portion 24) and the side wall portion 32 (the inner peripheral surface 32e of the side wall portion 32). The winding portion 20B may be accommodated in the recess 36, and thereafter, the resin 6 may be applied to the inner peripheral surface 32e of the side wall portion 32 (particularly, the position of the inner peripheral surface 32e, which faces the outer peripheral surface 24a of the dense portion 24).

In the present embodiment as well, effects similar to those of the first embodiment can be obtained. In addition, in the present embodiment, the dense portion 24 is closer to the opening of the recess 36 than the sparse portion 25. Therefore, the space between the dense portion 24 and the side wall portion 32 is easily filled with the resin 6, and the dense portion 24 and the side wall portion 32 are easily bonded by the resin 6.

### Fourth Embodiment

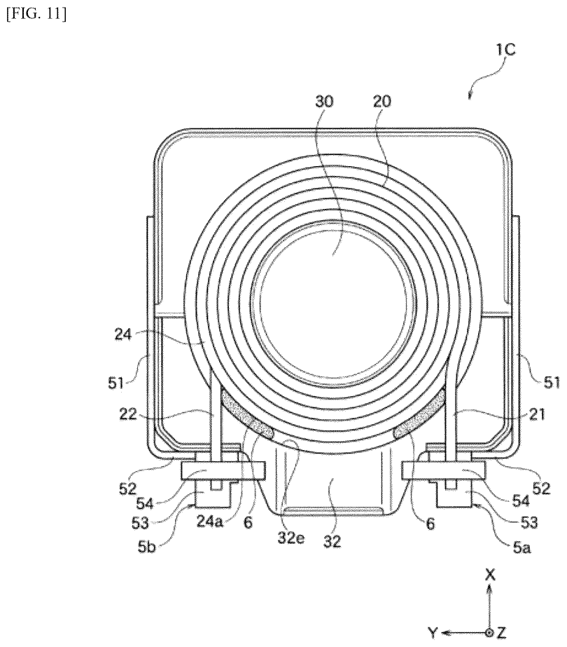

A coil device 1C of a fourth embodiment illustrated in FIG. 11 has a configuration similar to that of the coil device 1 of the first embodiment, except for the following points. Portions that overlap with the coil device 1 of the first embodiment are denoted by the same reference numerals, and detailed descriptions thereof will be omitted.

In the present embodiment, unlike the first embodiment, the resin 6 bonds (connects) the dense portion 24 and the side wall portion 32 locally rather than in all directions. Particularly, in the plan view of FIG. 11, the resin 6 locally bonds the dense portion 24 (the outer peripheral surface 24a of the dense portion 24) and the side wall portion 32 (the inner peripheral surface 32e of the side wall portion 32) along a path that connects the outer peripheral surface of the winding portion 20 and the terminal 5a or 5b in the shortest distance. In addition, the resin 6 also locally bonds the dense portion 24 and the side wall portion 32 around the path in addition to along the path that connects the outer peripheral surface of the winding portion 20 and the terminal 5a or 5b in the shortest distance.

In an example illustrated in FIG. 11, in a plan view, the path that connects the outer peripheral surface of the winding portion 20 and the terminal 5a or 5b in the shortest distance is, for example, a path that connects the outer peripheral surface 24a of the dense portion 24 and the second side portion 52 in the shortest distance. However, in a plan view, the path that connects the outer peripheral surface of the winding portion 20 and the terminal 5a or 5b in the shortest distance may be a path that connects the outer peripheral surface 24a of the dense portion 24 and the first side portion 51 in the shortest distance. Alternatively, in a plan view, the path that connects the outer peripheral surface of the winding portion 20 and the terminal 5a or 5b in the shortest distance may be a path that connects the outer peripheral surface 24a of the dense portion 24 and the wire connecting portion 53 in the shortest distance. Alternatively, in a plan view, the path that connects the outer peripheral surface of the winding portion 20 and the terminal 5a or 5b in the shortest distance may be a path that connects the outer peripheral surface 24a of the dense portion 24 and the crimping portion 54 in the shortest distance.

In the present embodiment as well, effects similar to those of the first embodiment can be obtained. In addition, in the present embodiment, in the plan view of FIG. 11, the resin 6 locally bonds the dense portion 24 and the side wall portion 32 along the path that connects the outer peripheral surface of the winding portion 20 and the terminal 5a or 5b in the shortest distance. Therefore, heat generated in the winding portion 20 propagates to the side wall portion 32 via the resin 6 through the path that connects the outer peripheral surface of the winding portion 20 and the terminal 5a or 5b in the shortest distance. Then, the heat that has propagated to the side wall portion 32 propagates to the mounting substrate (not illustrated) via the terminal 5a or 5b.

Therefore, heat generated in the winding portion 20 can be efficiently dissipated. In addition, by locally bonding the dense portion 24 and the side wall portion 32 using the resin 6, the amount of the resin 6 with which the recess 36 is filled (applied) can be reduced. Accordingly, the amount of the resin 6 with which the recess 36 is filled is less likely to vary.

The present disclosure is not limited to the above-described embodiments, and various modifications can be made without departing from the scope of the present disclosure.

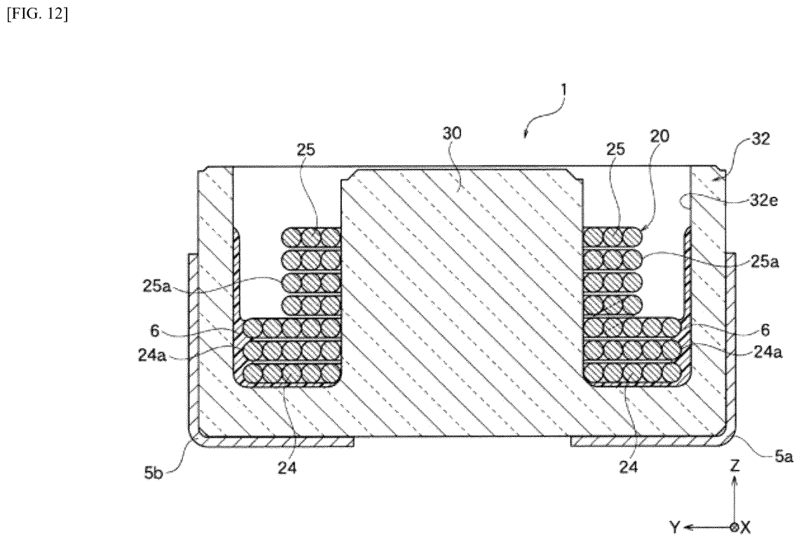

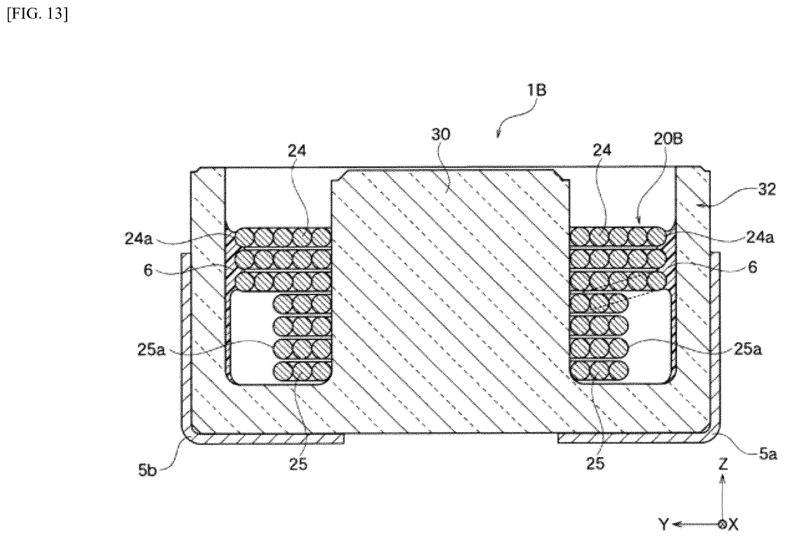

As illustrated in FIG. 12, in the first embodiment, the resin 6 that bonds (connects) the dense portion 24 and the side wall portion 32 may extend to the lateral side of the sparse portion 25 along the inner peripheral surface 32e of the side wall portion 32. In addition, as illustrated in FIG. 13, in the third embodiment, the resin 6 that bonds (connects) the dense portion 24 and the side wall portion 32 may extend to the lateral side of the sparse portion 25 along the inner peripheral surface 32e of the side wall portion 32.

### REFERENCE NUMERALS

1, 1A, 1B, 1C COIL DEVICE
2 WIRE
20, 20A, 20B WINDING PORTION
20a INNER PERIPHERAL SURFACE
24, 26 DENSE PORTION
24a, 26a OUTER PERIPHERAL SURFACE
25 SPARSE PORTION
25a OUTER PERIPHERAL SURFACE
21, 22 LEAD-OUT PORTION
23, 23a, 23b CONNECTING PORTION
3 FIRST CORE
30 CORE PORTION
30a OUTER PERIPHERAL SURFACE
32 SIDE WALL PORTION
32a FIRST SURFACE
32b SECOND SURFACE
32c THIRD SURFACE
32d FOURTH SURFACE
32e INNER PERIPHERAL SURFACE
34 BOTTOM WALL PORTION
36 RECESS
36a BOTTOM SURFACE
37a, 37b CUTOUT PORTION
38 PROTRUSION
39a, 39b RECESS
4 SECOND CORE
5a, 5b TERMINAL
50 MOUNTING PORTION
51 FIRST SIDE PORTION
52 SECOND SIDE PORTION
53 WIRE CONNECTING PORTION
54 CRIMPING PORTION
6 RESIN
6a SURFACE
6b UPPER SURFACE
6c LOWER SURFACE
60, 60m, 60n RECESS

What is claimed is:

1. A coil device, comprising:
a core including a core portion having a columnar shape, a side wall portion surrounding the core portion, and a recess located between the core portion and the side wall portion;
a wire including a winding portion accommodated in the recess and having a plurality of layers along a radial direction of the core portion, and a lead-out portion led out from the winding portion;
a resin adhered to the winding portion; and
a terminal connected to the lead-out portion and provided in the side wall portion,
wherein the winding portion includes a dense portion having a relatively large number of layers along a radial direction of the winding portion, and a sparse portion having a relatively small number of layers along the radial direction, and
the resin bonds the dense portion and the side wall portion without bonding the sparse portion and the side wall portion.

2. The coil device according to claim 1,
wherein the resin bonds an outer peripheral surface of the dense portion and an inner peripheral surface of the side wall portion.

3. The coil device according to claim 2,
wherein the resin further bonds a bottom surface of the dense portion and a bottom of the recess.

4. The coil device according to claim 1,
wherein the dense portion is closer to a bottom of the recess than the sparse portion.

5. The coil device according to claim 1,
wherein the dense portion includes a first dense portion and a second dense portion closer to a bottom of the recess than the first dense portion,
the sparse portion is located between the first dense portion and the second dense portion along an axial direction of the core portion, and
the resin bonds the second dense portion and the side wall portion.

6. The coil device according to claim 5,
wherein the resin bonds the second dense portion and the side wall portion without bonding the first dense portion and the side wall portion and without bonding the sparse portion and the side wall portion.

7. The coil device according to claim 1,
wherein in a cross-section parallel to an axial direction of the core portion, a surface of the resin is recessed toward a bottom of the recess between the dense portion and the side wall portion, and rises as the surface approaches the dense portion and the side wall portion.

8. The coil device according to claim 7,
wherein the surface of the resin is raised more in the vicinity of the side wall portion than in the vicinity of the dense portion.

9. The coil device according to claim 1,
wherein the resin does not bond the core portion and the dense portion.

10. The coil device according to claim 1,
wherein the dense portion is in contact with the core portion, whereas the dense portion is not in contact with the side wall portion and a bottom of the recess.

11. The coil device according to claim 1,
wherein, in a plan view, the resin locally bonds the dense portion and the side wall portion along a path that connects an outer peripheral surface of the winding portion and the terminal in a shortest distance.

12. A method for manufacturing a coil device, comprising the steps of:
preparing a winding portion including a dense portion having a relatively large number of layers along a radial direction and a sparse portion having a relatively small number of layers along the radial direction;
preparing a core including a core portion having a columnar shape, a side wall portion surrounding the core portion, and a recess located between the core portion and the side wall portion;
applying a resin to the recess; and
accommodating the winding portion in the recess and allowing the resin to enter between the dense portion and the side wall portion.
